(19) United States
(12) Patent Application Publication
(10) Pub. No.: US 2026/0222513 A1
(43) Pub. Date: Jul. 30, 2026

(54) EFFECT PROCESSING METHOD AND APPARATUS, AND ELECTRONIC DEVICE AND STORAGE MEDIUM

(71) Applicant: Beijing Zitiao Network Technology Co., Ltd., Haidian District, Beijing (CN)

(72) Inventor: Xubin ZHOU, Beijing (CN)

(21) Appl. No.: 19/149,218

(22) PCT Filed: Jan. 5, 2024
(86) PCT No.: PCT/CN2024/070848

§ 371 Date: Jul. 18, 2025

(30) Foreign Application Priority Data
Jan. 18, 2023 (CN) 202310102143.2

(51) Int. Cl. H04N 5/262; H04N 5/265; H04N 21/4402

(52) U.S. Cl. CPC H04N 5/2621; H04N 5/265; H04N 21/440281

(57) ABSTRACT

An effect processing method and an effect processing apparatus, an electronic device, and a storage medium are provided. The effect processing method includes: displaying, in response to an effect trigger operation for a speed-change effect, an effect capture image, a capture object in the effect capture image being displayed at a first speed; determining, when it is detected that a preset speed-change condition is reached, a display image corresponding to a second speed based on the effect capture image, the first speed, and the second speed; and displaying the display image corresponding to the second speed, so that the capture object in the effect capture image is displayed at the second speed.

The present application claims the priority of the Chinese patent application No. 202310102143.2 filed on Jan. 18, 2023, the disclosure of which is incorporated herein by reference in its entirety to constitute a part of the present application.

### TECHNICAL FIELD

The embodiments of the present disclosure relate to an effect processing method and an effect processing apparatus, an electronic device, and a storage medium.

### BACKGROUND

As smart terminals develop continuously, videos, as one of the important ways to carry information, have been favored by majority of users. In order to diversify the display of videos, in some scenarios, image frames in videos are played in a speed-change way to improve perception of users.

In related technologies, to speed up or slow down a video, it is often necessary to import an image into a video editing tool after the image is captured to adjust the overall playback speed of the image through the video editing tool. This way of achieving speed-change effect requires the user to have certain video editing skills, leading to cumbersome operation and poor time efficiency, which affects the user experience.

### SUMMARY

The present disclosure provides an effect processing method, an effect processing apparatus, an electronic device, and a storage medium to achieve real-time processing of speed-change effect in the process of image capturing.

In a first aspect, embodiments of the present disclosure provide an effect processing method, including: displaying, in response to an effect trigger operation for a target speed-change effect, an effect capture image, a capture object in the effect capture image being displayed at a first speed; determining, when it is detected that a preset speed-change condition is reached, a target display image corresponding to a second speed based on the effect capture image, the first speed, and the second speed; and displaying the target display image corresponding to the second speed, so that the capture object in the effect capture image is displayed at the second speed.

In a second aspect, embodiments of the present disclosure further provide an effect processing apparatus, including: an image capturing module configured to display, in response to an effect trigger operation for a target speed-change effect, an effect capture image, a capture object in the effect capture image being displayed at a first speed; a speed-change response module configured to determine, when it is detected that a preset speed-change condition is reached, a target display image corresponding to a second speed based on the effect capture image, the first speed, and the second speed; and an image display module configured to display the target display image corresponding to the second speed, so that the capture object in the effect capture image is displayed at the second speed.

In a third aspect, embodiments of the present disclosure further provide an electronic device, including: one or more processors; and a storage apparatus configured to store one or more programs; the one or more programs, when executed by the one or more processors, cause the one or more processors to perform the effect processing method as described in any one of the embodiments of the present disclosure.

In a fourth aspect, embodiments of the present disclosure further provide a storage medium containing a computer-executed instruction, characterized in that the computer-executed instruction, when executed by a computer processor, cause the computer processor to perform the effect processing method as described in any one of the embodiments of the present disclosure.

### BRIEF DESCRIPTION OF DRAWINGS

The above and other features, advantages, and aspects of the embodiments of the present disclosure will become more clearly in conjunction with the attached drawings and with reference to the specific embodiments below. Throughout the drawings, identical or similar reference numerals indicate identical or similar elements. It should be understood that the drawings are schematic and that the components and elements are not necessarily drawn to scale.

FIG. 1 is a schematic flow chart of an effect processing method provided by an embodiment of the present disclosure;

FIG. 2 is a schematic flow chart of another effect processing method provided by an embodiment of the present disclosure;

FIG. 3 is a schematic flow chart of another effect processing method provided by an embodiment of the present disclosure;

FIG. 4 is a schematic diagram of an instance of caching an effect capture image based on a preset cache window provided by an embodiment of the present disclosure;

FIG. 5 is a schematic diagram of an instance of performing an effect processing on an effect capture image in a fast-slow-fast mode provided by an embodiment of the present disclosure;

FIG. 6 is a schematic diagram of another instance of performing an effect processing on an effect capture image in a fast-slow-fast mode provided by an embodiment of the present disclosure;

FIG. 7 is a schematic diagram of another instance of performing an effect processing on an effect capture image in a fast-slow-fast mode provided by an embodiment of the present disclosure;

FIG. 8 is a schematic diagram of an instance of performing an effect processing on an effect capture image in a slow-fast-slow mode provided by an embodiment of the present disclosure;

FIG. 9 is a schematic diagram of another instance of performing an effect processing on an effect capture image in a slow-fast-slow mode provided by an embodiment of the present disclosure;

FIG. 10 is a schematic diagram of another instance of performing an effect processing on an effect capture image in a slow-fast-slow mode provided by an embodiment of the present disclosure;

FIG. 11 is a schematic diagram of another instance of performing an effect processing on an effect capture image in a slow-fast-slow mode provided by an embodiment of the present disclosure;

FIG. 12 is a schematic structural diagram of an effect processing apparatus provided by an embodiment of the present disclosure; and

FIG. 13 is a schematic structural diagram of an electronic device provided by an embodiment of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure can be implemented in various forms and should not be construed as limited to the embodiments set forth herein, instead, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that method embodiments of the present disclosure may be performed in a different order and/or in parallel. Furthermore, method embodiments may include additional steps and/or omit steps. The scope of the present disclosure is not limited in this respect.

The term “including” and its variants used herein are open-ended including, that is, “including but not limited to”. The term “based on” is “at least partially based on”. The term “one embodiment” means “at least one embodiment”; the term “another embodiment” means “at least one other embodiment”; the term “some embodiments” means “at least some embodiments”. Related definitions of other terms will be given in the following description.

It should be noted that the concepts of “first” and “second” mentioned in this disclosure are only used to distinguish different devices, modules or units, and are not used to limit the order or interdependence of the functions performed by these devices, modules or units.

It should be noted that the modifications of “a” and “a plurality of” mentioned in this disclosure are schematic rather than limiting, and those skilled in the art should understand that unless the context clearly indicates otherwise, they should be understood as “one or more”.

The names of messages or information exchanged between multiple apparatuses in the implementations of the present disclosure are for illustrative purposes only and are not intended to limit the scope of the messages or information.

It should be understood that before using the technical solutions disclosed in the embodiments of the present disclosure, the type, scope of use, use scenarios, and the like of personal information involved in the present disclosure must be informed to users and authorization must be obtained from the users through appropriate means in accordance with relevant laws and regulations.

For example, in response to receiving an active request from a user, a prompt is sent to the user to explicitly inform the user that acquisition and use of personal information of the user are required to perform the action that is requested. In this way, the user may choose, at its sole discretion, whether to provide the personal information to software or hardware such as an electronic device, an application, a server, or a storage medium that performs operations of the technical solution of the present disclosure according to the prompt.

As an optional but non-limiting implementation, in response to receiving an active request from a user, a prompt is sent to the user by means such as a pop-up window, where the pop-up window may present the prompt in a form of text. In addition, the pop-up window may also carry a selection control for the user to choose whether to Agree or Disagree to provide the personal information to the electronic device.

It should be understood that the foregoing process of notifying the user and the obtaining authorization from the user are only illustrative and do not limit the implementations of the present disclosure, and other means that meet relevant laws and regulations may also be applied in the implementations of the present disclosure.

It should be understood that the data involved in the technical solution of the present disclosure (including but not limited to the data itself, the acquisition or use of data) shall comply with the requirements of relevant laws and regulations and relevant provisions.

FIG. 1 is a schematic flow chart of an effect processing method provided by an embodiment of the present disclosure. The embodiment of the present disclosure is applicable to a scenario in which a speed-change effect is displayed while the effect capture image is being captured. The method may be performed by an effect processing apparatus, which may be implemented by means of software and/or hardware. Optionally, the electronic device for processing the effect may be a mobile terminal, a PC terminal a server, or the like.

As shown in FIG. 1, the method in the present embodiment may specifically include:

S110: Displaying, in response to an effect trigger operation for a target speed-change effect, an effect capture image; a capture object in the effect capture image being displayed at a first speed.

The target speed-change effect may be understood as an effect for speed-change processing on the effect capture image. It should be noted that the target speed-change effect may have one or more speed-change modes, such as slowing down, speeding up, slowing down and then speeding up, or speeding up and then slowing down. The speed-change effect includes at least one selected from the group consisting of seamless transition, speed-change rhythm synchronization, and slow-motion display. The effect trigger operation may be understood as an operation that, after being triggered, activates the target speed-change effect, so as to perform a speed-change effect process on the effect capture image. The effect capture image may be understood as a capture image used for the target speed-change effect, or an image that is captured with the target speed-change effect being activated.

In the embodiments of the present disclosure, the target speed-change effect may be triggered by several ways. As an example, one or more speed-change effects may be presented in a capturing interface of a capturing device for selection by the user. Furthermore, in response to the selection of the target speed-change effect displayed in the capturing interface, the selected speed-change effect may be used as the target speed-change effect. For example, when a user captures through a capturing device, when the user clicks on a capturing operation to enter the capturing interface, a speed-change effect control may be displayed on the capturing screen in a floating way, or the speed-change effect control may be displayed at an effect control position on the capturing interface. Furthermore, after the user triggers the speed-change effect control, the speed-change effect control displays a plurality of speed-change effects for the user to select, and uses the speed-change effect selected by the user as the target speed-change effect. The effects capturing control may be a physical capturing control of the capturing device, or a virtual capturing control that is displayed on the capturing interface. The effect capturing control may be an independently provided capturing control. Alternatively, the effect capturing control may be a selection control corresponding to a speed-change effect. When the user selects a speed-change effect as the target speed-change effect, the effect capturing control is triggered at the same time. The capturing device may be any device that has the capability of capturing. Typically, it may be an external camera of a terminal or a built-in camera of a terminal.

Specifically, when the capturing function of the capturing device is activated, the capturing interface of the capturing device is displayed, and multiple speed-change effects may be displayed on the capturing interface for the user to select. In response to the selection operation for the multiple speed-change effects displayed in the capturing interface by the user, a speed-change effect selection event is triggered, and the speed-change effect selected by the user is regarded as the target speed-change effect. The image captured by the capturing device is then an effect capture image. Optionally, the effect display page is displayed, the effect display page includes at least one speed-change effect identifier. In response to the selection operation of the effect identifier, the speed-change effect corresponding to the selected effect identifier is used as the target speed-change effect. Furthermore, in response to receiving the activating and trigger operation for the target speed-change effect, the capturing interface is displayed, and image displayed in the capturing interface is regarded as an effect capture image.

A capture object may be one or more image main bodies in the effect capture image. Optionally, the capture object may be all the image information in the effect capture image. For example, an effect capture image may be a scene, a composite image consisting of person and person, person and thing, and thing and thing. The capture object may be a portrait or an object captured in the effect capture image. For example, the effect capture image may be a dancing image of the user, and the dancing user may be the capture object. The effect capture image may record an action of an animal, and the animal may be regarded as the capture object. The effect capture image may record a rainy city and the rain is the capture object.

In the embodiments of the present disclosure, the speed of displaying the capture object is associated with the speed of displaying the effect capture image. The first speed may be the normal playback speed of the effect capture image during capturing. It should be noted that the first speed is associated with the capturing device that captures the effect capture image, and is usually the default playback speed of the capturing device during capturing. To display in real time, optionally, the default playback speed of the capturing device is the same as the capturing speed of the effect capture image. For example, when the effect capture image captured by the capturing device is an image of 60 frames, the playback speed of the effect capture image may be 60 frames per second. When the effect capture image captured by the capturing device is an image of 120 frames, the playback speed of the effect capture image may be 120 frames per second.

Specifically, in response to the effect trigger operation of the target speed-change effect by the user, the effect capture image that is being captured is displayed at the first speed, so that the capture object in the effect capture image is displayed at the first speed.

S120: Determining, when it is detected that a preset speed-change condition is reached, a target display image corresponding to the second speed based on the effect capture image, the first speed, and the second speed.

A preset speed-change condition may be a preset condition that is configured to determine whether an effect capture image starts to change speed.

Optionally, in the embodiments of the present disclosure, the preset speed-change condition includes at least one of the following conditions:
the audio information associated with the target speed-change effect is played to a preset audio node;
the effect capture image includes preset image information, the preset image information including a preset image main body and/or preset action information;
a control instruction for triggering the start of a speed-change is received, the control instruction being generated based on an input sound and/or based on a control trigger operation on a preset control; and
a duration of capturing the effect capture image reaches a first preset duration.

The audio information may be the audio information played in the process of displaying the effect capture image, and the audio information is associated with the target speed-change effect. A preset audio node may be an audio node that is preset to change the speed of the effect capture image according to the target speed-change effect. As an example, an audio node may be a rhythm point, a beat point, or a playback time, or the like. Optionally, the target speed-change effect may be associated with an audio information, and when the audio information is played to the preset audio node, a speed-change is performed on the effect capture image that is playing back.

The preset image main body can be an image main body of a preset type. The preset image main body may be a person, an object (for example, an animal, a plant, or a building), and a natural phenomenon (rain, snow, hail, or the like). During the display of the effect capture image, when it is detected that the effect capture image is displayed to the preset image main body, an effect speed-change is performed on the effect capture image. It should be noted that considering that different image main bodies are included in different effect capture images, multiple types of preset image main bodies may be set. As an example, the effect capture image may be an image of an ancient city, and the preset image main body may be the city gate.

The preset action information may be action information included in the preset image. There may be a variety of preset action information. As an example, the preset action information may be a hand movement (for example, waving), an eye movement (for example, blinking), or a head movement (for example, nodding or shaking the head). In the process of displaying the effect capture image, when it is detected that the effect capture image is displayed to the preset action information, an effect speed-change is performed on the effect capture image according to the target speed-change effect.

In the embodiments of the present disclosure, the preset speed-change condition may include a preset image main body and preset action information. Optionally, in the process of displaying the effect capture image, when it is detected that the effect capture image displays that the preset image main body meets the preset action information, or when it is detected that the preset image main body appears after the preset action information, a speed-change process is performed on the effect capture image according to the target speed-change effect. For example, the preset speed-change condition may be set to “a dancer waves his or her hand”, then in the process of displaying the effect capture image, when it is detected that the dancer waves his or her hand, the preset speed-change condition is considered to be met, and an effect speed-change is performed on the effect capture image according to the target speed-change effect. In a case where only a dancer or a waving motion is detected, the preset speed-change condition is not considered to be met, and the effect capture image continues to be played back at the first speed.

The control instruction may be an instruction that controls the effect capture image to undergo an effect speed-change. The control instruction is generated based on an input sound and/or based on a control trigger operation on a preset control.

Optionally, the control instruction may be an instruction generated based on an input sound. Typically, this may be a voice instruction input by the user. Optionally, the control instruction may be generated based on a trigger operation for operating a preset control. When it is detected of a control trigger operation for a preset control, the preset speed-change condition is considered to be met.

The first preset duration may be a preset duration to record the effect capture image continuously. As an example, the duration starts from the moment the target speed-change effect is triggered.

Optionally, whether the duration of the effect capture image has reached the first preset duration is determined. When the duration of the effect capture image does not reach the first preset duration, return to the operation of determining whether the duration of the effect capture image reaches the first preset duration. In a case where the duration of the effect capture image reaches the first preset duration, the preset speed-change condition is considered to be met. The second speed may be the changed image display speed corresponding to the target speed-change effect. It is noted that at the second speed, the number of frames displayed per second is the same as that at the first speed. For example, when 60 frames are displayed per second at the first speed, also 60 frames are displayed at the second speed.

Optionally, the second speed may be the changed display speed of the effect capture image. In the embodiments of the present disclosure, a speed-change setting operation for the target speed-change effect may be received. For example, an effect setting control may be provided in the target speed-change effect to set the speed-change. Furthermore, the speed for displaying the effect capture image may be set through the effect setting control, and the second speed may be further determined according to the speed-change setting operation.

The target display image may be a display image obtained after performing a speed-change process on the effect capture image. In a real-time speed-change scenario, the target display image may also be understood as the screen output image at the current moment. It should be understood that the number of target display images is associated with the changed second speed. Therefore, the number of target display images may be one or more frames.

Optionally, the speed-change mode corresponding to the second speed may be determined according to the first speed and the second speed, and the image processing mode may be determined according to the speed-change mode. The image processing mode includes inserting a frame or skipping a frame. Furthermore, according to the image processing mode and the effect capture image that has been taken, the target display image corresponding to the second speed is determined.

As an example, the target speed-change effect may be a slow-motion display effect. For example, if the slow-motion display effect plays at a 4 times speed-change, one frame of slow-down image of the effect capture image needs to be played in every four frames of the display image, thereby further filling the other three frames. In this case, a frame may be generated to be inserted between the slow-motion frame and the next frame of the effect capture image, so as to achieve smooth speed-change and avoid visual stuttering caused by continuous display of the same effect capture image.

Optionally, the target speed-change effect may be a slow-motion display effect. For example, if the slow-motion display effect plays at a 3 times speed-change, 4 fast-speed frames of the effect capture image needs to be played in every 2 frames of the display image. Considering that the images are captured and displayed in a capturing device at a frequency that is often indistinguishable to human eyes, a preset number of frames may be skipped to achieve the fast-speed playback.

The technical solutions of the embodiments of the present disclosure can, without modifying the number of frames displayed in the image, insert or skip frames in the process of displaying the image, so as to form a visual curve speed-change effect. This curve speed-change mode can highlight the focus of the image, so as to improve the high-class experience and rhythm of the image in the display process.

Specifically, in the process of displaying the effect capture image at the first speed, whether the effect capture image reaches the preset speed-change condition is detected. When it is detected that the preset speed-change condition is reached, the target display image corresponding to the second speed according to the effect capture image, the first speed, and the second speed is determined.

S130: Displaying the target display image corresponding to the second speed, so that the capture object in the effect capture image is displayed at the second speed.

Specifically, after determining the target display object corresponding to the second speed, the target display image corresponding to the second speed may be displayed according to the preset image display frame rate, and the displayed image is changed so that the capture object in the effect capture image presents the effect of being displayed at the second speed.

In the embodiments of the present disclosure, the effect capture image is displayed in response to the effect trigger operation for the target speed-change effect, the capture object in the effect capture image is displayed at the first speed, such that capturing may be carried out in the application scenario of the target speed-change effect, a speed-change effect may be provided in the capturing process, which requires no manual post processing from the user, thereby providing simple interaction and convenient operation. Then, when it is detected that the preset speed-change condition is reached, the target display image corresponding to the second speed is determined based on the effect capture image, the first speed, and the second speed. During the capturing process, the target display image at the second speed may be automatically determined according to the effect capture image at the first speed, so as to achieve the speed-change effect. Finally, the target display image corresponding to the second speed is displayed, so that the capture object in the effect capture image is displayed at the second speed, such that the user can immediately view the speed-change effect after applying the target speed-change effect in the capturing process, thereby providing the speed-change effect while capturing, and improving the high-class experience and rhythm of the effect capture image. It solves the technical problem of cumbersome operation and poor timeliness caused by performing speed-change effect through video post-processing, achieves speed-change display of the effect capture image, and simplifies the speed-change operation mode, thereby saving the effect processing time, improving the timeliness of speed-change display, and improving the technical effect of user interaction and viewing experience.

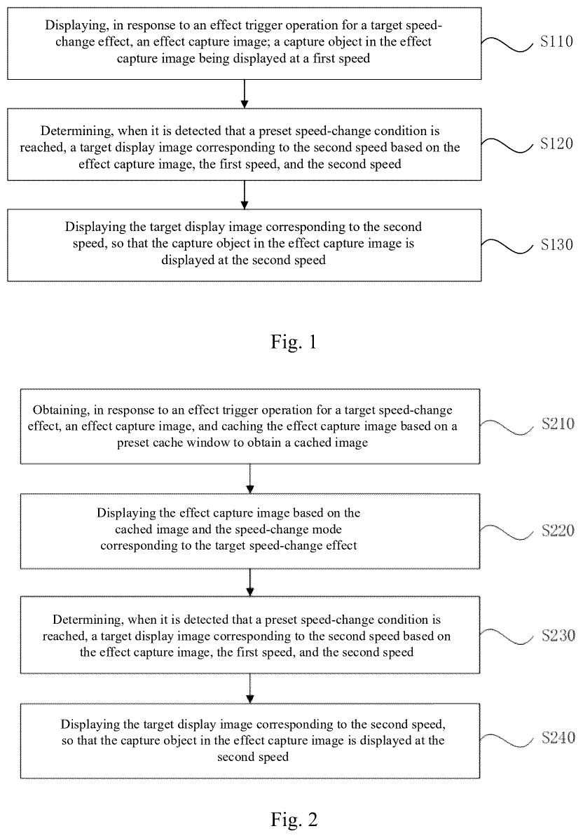

FIG. 2 is a schematic flow chart of another effect processing method provided by an embodiment of the present disclosure. Based on the above embodiment, the technical solution of the present embodiment further refines how to display the effect capture image. For specific implementations, refer to the description of the present embodiment. The technical features that are identical or similar to the foregoing embodiments are not described again here.

As shown in FIG. 2, the method in the present embodiment may specifically include:

S210: Obtaining, in response to an effect trigger operation for a target speed-change effect, an effect capture image, and caching the effect capture image based on a preset cache window to obtain a cached image.

The preset cache window can be a cache window that is preset for caching the effect capture image. The preset cache window is associated with the number of caches for the effect capture image. Optionally, the preset cache window may be configured to cache a multi-frame effect capture image. Specifically, based on the preset cache window, the effect capture image with the preset number of cached frames are cached sequentially according to the capturing time.

The cached image may be understood as a cached effect capture image.

Optionally, when caching the effect capture image through the preset cache window, because the number of effect capture images that are captured keeps increasing, the cached effect capture images also increase, in order to prevent too much caching and affecting the caching of the effect capture image, the oldest effect capture image that is cached may be removed when the upper limit of the number of frames cached is exceeded, so as to cache the latest effect capture image. The cache size of the preset cache window may be set according to the target speed-change effect, which is not specifically limited here.

Specifically, the preset cache window is set in advance, and when the effect capture image is obtained, the effect capture image is cached based on the preset cache window at the same time to obtain the cached image.

As an example, FIG. 4 is a schematic diagram of caching an effect capture image based on a preset cache window provided by an embodiment of the present disclosure. As shown in FIG. 4, when capturing an effect capture image, the screen simultaneously outputs the effect capture image that is input and captured in real time. FIG. 4 shows a 10-frame effect capture image, the box represents a preset cache window, and the preset cache window can cache the 8 frames of the effect capture image that are captured in real time. After frames 1-8 are cached in the preset cache window, when capturing the 9^{th} frame of the effect capture image, the cached effect capture images exceed 8 frames, and the first cached image of the effect capture images may be removed, and the 9^{th} frame of the effect capture image may be cached. Similarly, when capturing a 10^{th} frame of the effect capture image, the 2^{nd} cached image of the effect capture image that is cached first may be removed to cache the 10^{th} frame of the effect capture image.

Optionally, in the preset cache window, the cached images of the effect capture image are arranged in sequence, and the position of each frame of the effect capture image in the preset cache window is recorded. When new effect capture images are sequentially cached in the preset cache window, the old frames with the longest cache time are removed, and the position of each frame of the effect capture image in the preset cache window is modified accordingly.

FIG. 4 follows FIG. 4, the preset cache window may cache 8 frames of the effect capture image. At this moment, the preset cache window caches the frames 3 to 10, and the positions of the frames 3 to 10 in the preset cache window are recorded as F(1), F(2), . . . , F(n=8), where F is the preset cache window, F(1) represents the frame 3 of effect capture image, and so on . . . , and F(8) is frame 10 of the effect capture image. When capturing frame 11 of the effect capture image in real time, the frame 3 of the effect capture image cached first is removed, and the frame 11 of the effect capture image is cached. In this case, F(1) represents the frame 4 of the effect capture image, and so on . . . , and F(8) is the frame 11 of the effect capture image.

S220: Displaying the effect capture image based on the cached image and the speed-change mode corresponding to the target speed-change effect.

The speed-change mode may be understood as the speeding changing trend, which may include a slow-to-fast mode and a fast-to-slow mode. It should be noted that the speed-change mode does not change the number of display frames per second of the effect capture image, and on the premise of keeping the number of display frames per second of the effect capture image unchanged, the speed of the displayed effect capture image may be adjusted according to the speed-change mode through adding frames or skipping frames.

Specifically, the speed-change mode corresponding to the target speed-change effect is determined, and the effect capture image is displayed based on the cached images cached in the preset cache window and the speed-change mode.

Optionally, in another optional embodiment of the present disclosure, the displaying the effect capture image based on the cached images and the speed-change mode corresponding to the target speed-change effect includes: displaying the cached image in real time in a case where the speed-change mode corresponding to the target speed-change effect is a fast-to-slow mode.

The fast-to-slow mode may be understood as a situation where the first speed is greater than the second speed. Specifically, in a case where the speed-change mode corresponding to the target speed-change effect is a slow-to-fast mode, the cached images cached in the preset cache window are obtained in real time for display, and the cached image is synchronized with the display image to display the effect capture image in real time.

Optionally, in a case where the speed-change mode corresponding to the target speed-change effect is a fast-to-slow mode, the effect capture image is displayed by delaying the first preset number of frames based on the cached image. The advantage of this setting is that by delaying the cached effect capture image by the first preset number of frames for display, the stuttering during the capturing process can be better dealt with, thereby effectively ensuring the display smoothness of the effect capture image. Optionally, in another optional embodiment of the present disclosure, the displaying the effect capture image based on the cached image and the speed-change mode corresponding to the target speed-change effect includes: displaying, when the speed-change mode corresponding to the target speed-change effect is a slow-to-fast mode, the effect capture image by delaying the second preset number of frames based on the cached image.

The slow-to-fast mode may be understood as a situation where the first speed is smaller than the second speed. It should be noted that in the slow-to-fast mode, because the future effect capture image cannot be obtained in advance, the preset cache window can only cache the effect capture images that are captured in real time, and the cached effect capture image needs to be output in a delayed mode. In this way, the effect capture image displayed on the screen is sped up to the number of frames corresponding to the effect capture image captured in real time by skipping frames.

The first number of preset frames and the second number of preset frames may be the number of frames that are preset to delay the effect capture image. The first preset number of frames and the second preset number of frames may be the same or different. In the embodiments of the present disclosure, optionally, the second preset number of frames is greater than the first preset number of frames.

Specifically, in a case where the speed-change mode corresponding to the target speed-change effect is a fast-to-slow mode, the second preset number of frames to be delayed is obtained, and the cached image is displayed with delay according to the second preset number of frames, so as to achieve the effect of changing faster of the displaying of the effect capture image.

S230: Determining, when it is detected that a preset speed-change condition is reached, a target display image corresponding to the second speed based on the effect capture image, the first speed, and the second speed.

Optionally, in the embodiments of the present disclosure, the determining the target display image corresponding to the second speed based on the effect capture image, the first speed, and the second speed includes: obtaining, in a case where the first speed is greater than the second speed, the currently displayed effect capture image as a first image, and obtaining the effect capture image of the next frame of the first image from the cached image as a second image; determining a supplementary image with a preset number of supplementary frames corresponding to the second speed based on the first image and the second image, and successively taking the supplementary image and the second image with the preset number of supplementary frames as the target display image corresponding to the second speed.

The preset number of supplementary frames may be the frames to be inserted that are determined based on the second speed. Optionally, the speed difference between the first speed and the second speed may be determined, the difference multiple between the speed difference and the second speed may be determined, and the preset number of supplementary frames may be determined according to the difference multiple. As an example, the first speed may be 4 times the second speed, and the difference multiple between the first speed and second speed is 3, the preset number of supplementary frames between the first image and second image are 3 frames.

The supplementary images may be understood as images that are used to supplement between the first image and the second image. The supplementary images may be generated from the first image and second image. Optionally, in a case where the first speed is greater than the second speed, the displayed effect capture image may be supplemented with frames to achieve the effect of slow motion. In order to ensure the coherence of the target display image, frames may be supplemented according to the effect capture image and the next frame of the effect capture image, so as to prevent the visual stuttering of the target display image.

Optionally, in the process of supplementing frames according to the first image and the second image, the preset number of supplementary frames to be supplemented between the first image and the second image according to the first speed and the second speed is determined, and a supplementary image with the preset number of supplementary frames is generated according to the first image and the second image.

Optionally, in a case where the first speed is greater than the second speed, the currently displayed effect capture image is obtained as a first image, and the effect capture image of the next frame of the first image is obtained from the cached image in the preset cache window as a second image, thereby determining a supplementary image with a preset number of supplementary frames corresponding to the second speed based on the first image and the second image, and the supplementary image with the preset number of supplementary frames and the second image are successively regarded as the target display image corresponding to the second speed.

As an example, in a case where the first speed is greater than the second speed, the speed-change is triggered at the frame 10 of the effect capture image. In this case, frames need to be filled after the frame 10 of the effect capture image and before the frame 11 of the effect capture image. When the cached image is the frame 11 of the effect capture image, the frame 11 output on the screen shall be a supplementary image determined based on the frame 10 of the effect capture image and the frame 11 of the effect capture image. In other words, if the frames 4 to 11 of the cached images are cached in the preset cache window, the cached frame 10 of the effect capture image is obtained as the first image, the cached frame 11 of the effect capture image is obtained as the second image, and the supplementary image corresponding to the second speed is determined according to the frames 10 and 11 of the effect capture image and the preset number of supplementary frames.

Optionally, in another optional embodiment of the present disclosure, the determining a supplementary image with a preset number of supplementary frames corresponding to the second speed based on the first image and the second image includes: performing weighted fusion on the first image and the second image to obtain the supplementary image with the preset number of frames corresponding to the second speed.

Optionally, a supplementary image with a preset number of supplementary frames corresponding to the second speed is determined based on the first image and the second image; the first weight corresponding to the first image and the second weight corresponding to the second image are respectively determined according to the preset number of supplementary frames and the relative display position of the supplementary frames; and furthermore, the first image and the second image are weighted and fused based on the first weight and the second weight to obtain the supplementary image corresponding to the second speed. The relative display position is determined by the number of frames between the supplementary image and the first image and by the number of frames between the supplementary image and the second image.

Specifically, if the display position of the supplementary image in the target display image is closer to the first image, then in the weighted fusion of the supplementary image, the weight of the first image may be greater than that of the second image. If the display position of the supplementary image in the target display image is close to the second image, then in the weighted fusion of the supplementary image, the weight of the first image may be smaller than that of the second image. If the display position of a supplemental image is at the same interval from the display position of the first image and second image, then in the weighted fusion of the supplementary image, the weight of the first image may be equal to the weight of the second image. The benefit of this is that it provides smoother effect for the display of the target display image.

As an example, when the first speed is greater than the second speed, frames need to be filled after the frame 10 of the effect capture image and before the frame 11 of the effect capture image. Assuming that the preset number of supplementary frames is 2, the frame 11 and frame 12 of the screen output should be the supplementary frames. If frames 5 to 11 of the cached image are cached in the preset cache window, the cached frame 10 of the effect capture image is obtained as the first image, the cached frame 11 of the effect capture image is obtained as the second image. Because the display position of frame 11 is closer to frame 10, in the supplementary image of frame 11, the weight of the first image is greater than that of the second image, and because the display position of frame 12 is closer to frame 11 of the effect capture image, in the supplementary image of frame 12, the weight of the first image is smaller than that of the second image.

Specifically, a weighted fusion is performed on the first image and the second image to obtain the supplementary image with the preset number of frames corresponding to the second speed.

Optionally, the formula for performing weighted fusion on the first image and the second image is as follows:

$$mix ( x , y , m ) = x * m + y * ( 1 - m )$$

where x is the second image; y is the first image; and m is the weight for the weighted fusion.

Optionally, in another optional embodiments of the present disclosure, the determining the target display image corresponding to the second speed based on the effect capture image, the first speed, and the second speed includes: in a case where the first speed is smaller than the second speed, obtaining the effect capture image from the cached image as the target display image corresponding to the second speed based on the currently displayed effect capture image and a preset number of skipped frames corresponding to the second speed.

The preset number of skipped frames may be a preset number of frames to be skipped. The preset number of skipped frames is associated with the second speed.

Optionally, in a case where the first speed is lower than the second speed, the effect capture image may be skipped and displayed according to the preset number of skipped frames, thereby speeding up the playback of the effect capture image. As mentioned above, because it is not possible to obtain future effect capture images in advance in a capturing scene, it is possible to delay the effect capture image by a second preset number of frames for playback.

Optionally, after fast playback with skipped frames based on the preset number of skipped frames, the image may be supplemented with frames to make the delayed frames of the adjusted target display image output on the screen equal to the second preset number of frames.

Specifically, in a case where the first speed is smaller than the second speed and that the target speed-change effect is the fast-to-slow mode, the effect capture image is obtained from the cached image as the target display image corresponding to the second speed based on the currently displayed effect capture image and the preset number of skipped frames corresponding to the second speed.

S240: Displaying the target display image corresponding to the second speed, so that the capture object in the effect capture image is displayed at the second speed.

In the embodiments of the present disclosure, in response to the effect trigger operation for the target speed-change effect, obtaining the effect capture image and caching the effect capture image based on the preset cache window to obtain the cached image; the effect capture image may be cached in real time through the preset cache window, so that when the effect capture image is captured, a speed-change effect process is performed on the capture image through the cached image cached by the preset cache window, so as to achieve the speed-change effect while capturing. The effect capture image is displayed based on the cached image and the speed-change mode corresponding to the target speed-change effect; the corresponding speed-change mode is determined according to different target speed-change effects; and the effect capture image after the speed-change effect processing is displayed according to the target speed-change effect. This provides different speed-change effects for different speed curves, thereby enriching the effect of real-time speed-change effect processing.

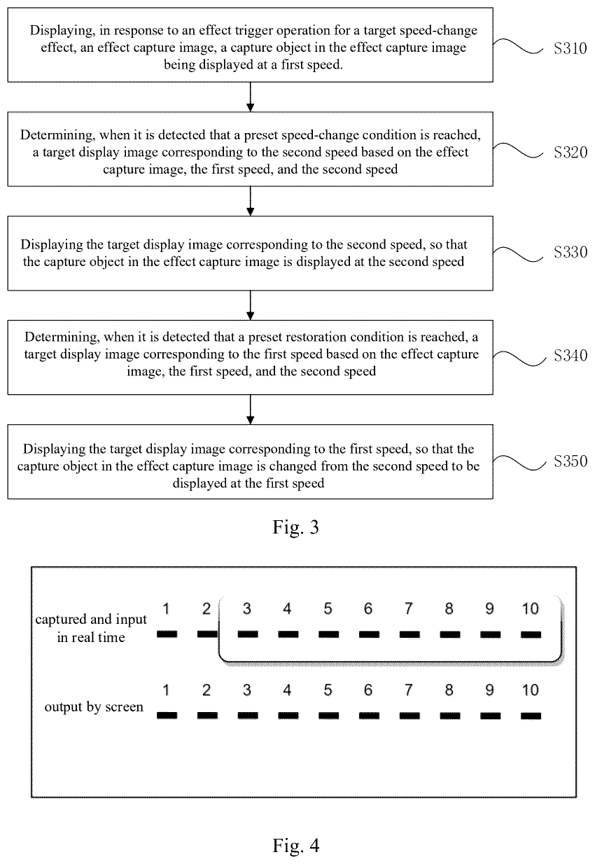

FIG. 3 is a schematic flow chart of another effect processing method provided by an embodiment of the present disclosure. On the basis of the above embodiments, in addition to describing how to display the target display image, the technical solution of the embodiment further explains how to restore the display of the target display image after displaying the capture object in the effect capture image at the second speed. For specific implementations, refer to the description of the present embodiment. The technical features that are identical or similar to the foregoing embodiments are not described again here.

As shown in FIG. 3, the method in the present embodiment may specifically include:
S310: Displaying, in response to an effect trigger operation for a target speed-change effect, an effect capture image, a capture object in the effect capture image being displayed at a first speed.
S320: Determining, when it is detected that a preset speed-change condition is reached, a target display image corresponding to the second speed based on the effect capture image, the first speed, and the second speed.
S330: Displaying the target display image corresponding to the second speed, so that the capture object in the effect capture image is displayed at the second speed.
S340: Determining, when it is detected that a preset restoration condition is reached, a target display image corresponding to the first speed based on the effect capture image, the first speed, and the second speed.

The preset restoration condition may be a preset condition for triggering the restore of the display speed of the effect capture image to return to the display speed before the change, that is, the condition for reverting from the second speed to the first speed.

Optionally, in the embodiments of the present disclosure, the preset restoration condition includes at least one of the following conditions:
a duration of displaying the capture object in the effect capture image at the second speed reaches a second preset duration;
the total number of effect capture images displayed at the second speed reaches a first preset quantity;
the total display number of target display images corresponding to the second speed reaches a second preset quantity.

The second preset duration may be the duration after the preset speed-change condition is triggered. Optionally, regarding determining whether the duration of the target display image has reached the second preset duration, in a case where the duration of the target display image does not reach the second preset duration, return to the operation of determining whether the duration of the display target image reaches the second preset duration; in a case where the duration of displaying the target display image reaches the second preset duration, the preset restoration condition is considered to have been met.

The first preset quantity may be the number of frames of the effect capture image displayed at the second speed. It should be noted that after the effect capture image reaches the preset speed-change condition, the number of frames of the effect capture image displayed at the second speed is recorded as the total number of effect capture images displayed at the second speed. Optionally, regarding determining whether the total number of effect capture images displayed at the second speed reaches the first preset quantity, in a case where the total number of effect capture images displayed at the second speed does not reach the first preset quantity, return to perform the operation of determining whether the total number of effect capture images displayed at the second speed reaches the first preset quantity; in a case where the total number of effect capture images displayed at the second speed reaches the first preset quantity, the preset restoration condition is considered to have been met.

The second preset quantity may be the number of frames of the target display image displayed at the second speed. It should be noted that after the effect capture image reaches the preset speed-change condition, the number of frames of the target display image that starts to be displayed at the second speed is recorded, and is used as the total number of frames of the target display image displayed at the second speed. Optionally, regarding determining whether the total number of target display images displayed at the second speed reaches the first preset quantity, in a case where the total number of target display images displayed at the second speed does not reach the first preset quantity, return to perform the operation of determining whether the total number of target display images displayed at the second speed reaches the first preset quantity; in a case where the total number of target display images displayed at the second speed reaches the first preset quantity, the preset restoration condition is considered to have been met. Optionally, the determining the target display image corresponding to the first speed based on the currently displayed effect capture image, the first speed, and the second speed includes: when the speed-change mode corresponding to the target speed-change effect is a slow-to-fast mode, restoring the target display image to the first speed normally displayed by means of frame skipping; and/or, when the speed-change mode corresponding to the target speed-change effect is a fast-to-slow mode, stopping the frame skipping to restore the target display image to the first speed normally displayed.

Optionally, in a case where the first speed is greater than the second speed, the effect capture image is obtained from the cached image as the target display image corresponding to the first speed based on the currently displayed effect capture image and the preset number of skipped frames corresponding to the first speed.

Optionally, in a case where the first speed is lower than the second speed, the currently displayed effect capture image is obtained as a first image, and the effect capture image of the next frame of the first image is obtained from the cached image as a second image; a supplementary image with a preset number of supplementary frames corresponding to the second speed is determined based on the first image and the second image, and the supplementary image with the preset number of supplementary frames and the second image are successively regarded as the target display image corresponding to the first speed. Specifically, in the process of displaying the target display image at the second speed, detect whether the target display image reaches the preset restoration condition. When it is detected that the preset restoration condition is reached, determine the target display image corresponding to the first speed according to the target display image, the first speed, and the second speed.
S350: Displaying the target display image corresponding to the first speed, so that the capture object in the effect capture image is changed from the second speed to be displayed at the first speed. Specifically, after determining the target display object corresponding to the first speed, the target display image corresponding to the first speed may be displayed according to the preset image display frame rate, such that the capture object in the effect capture image presents the effect of being displayed at the first speed.

As an example, the slow-to-fast mode may be a curve that slows down first and then speeds up. Specifically, in the slow-to-fast mode, the screen output of the effect capture image captured in real time may be slowed down by filling frames. After the frame filling is completed, the effect capture image displayed on the screen is sped up to the number of frames corresponding to the effect capture image captured in real time by skipping frames.

In the embodiments of the disclosure, when it is detected that the preset restoration condition is reached, determining a target display image corresponding to the first speed based on the currently displayed effect capture image, the first speed, and the second speed, and when it is detected of the preset restoration condition, restores the effect capture image that have been processed with the speed-change effect to play back at the first speed before the speed-change effect processing, which further enriches the display effect of the effect capture image, and makes the speed-change effect more obvious and also facilitates the use of the previous speed-change processing in the next speed change, thereby improving the interaction and viewing experience of users.

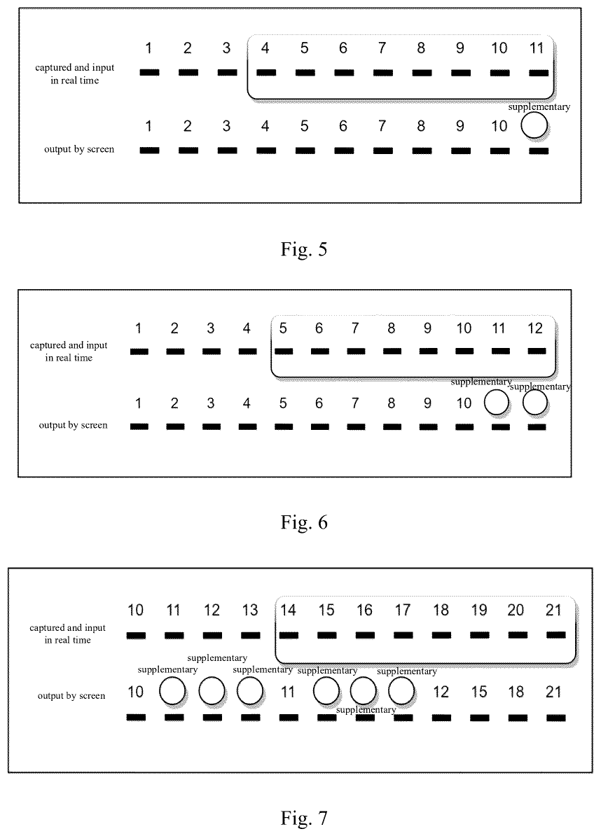

FIG. 5 is a schematic diagram of an example of performing effect processing on an effect capture image in a fast-slow-fast mode provided by the embodiment of the present disclosure. FIG. 6 is a schematic diagram of another example of performing effect processing on an effect capture image in a fast-slow-fast mode provided by the embodiment of the present disclosure. FIG. 7 is a schematic diagram of another example of performing effect processing on an effect capture image in a fast-slow-fast mode provided by the embodiment of the present disclosure.

FIG. 5 assumes that a preset speed-change condition is triggered when displaying frame 10 of the effect capture image, and the second speed after the speed change is lower than the first speed, then frames may be filled between frame 10 of the effect capture image and frame 11 of the effect capture image that are captured and input in real time. When the preset number of supplementary frames corresponding to the second speed is determined to be 3, in a case where the effect capture image that is captured and input is frame 11, the target display image output by the screen should be the supplementary image of frame 10 and frame 11. For example, the preset cache window is 8 frames of the effect capture image, F(n) is used to indicate the position of the effect capture image in the preset cache window, and n is taken from 1 to 8.

In the process of a fast-to-slow change, as shown in FIG. 5, frame 4 to frame 11 is cached in the preset cache window, then the cached image 10 of the effect capture image is obtained as the first image, the cached image 11 of the effect capture image is obtained as the second image. In this case, the supplementary image is the supplementary image at frame 11 in the screen output image, which may be obtained by weighted fusion on the first image and the second image, and the specific fusion mode may be mix(F(7),F(8),0.25), where 0.25 is the weight of F(8) of the second image, and so on . . . . As shown in FIG. 6, after supplementing the supplementary image of frame 11, the screen output image of frame 12 is continued to be supplemented, and because the supplementary image of frame 12 is the second frame supplementary image in the 3 frames of the supplementary image, that is, at the middle position, the weighted fusion mode of the first image and the second image for weighted fusion may be mix(F(6),F(7),0.5), where 0.5 is the weight of F(7) of the second image, and so on . . . . As shown in FIG. 7, for the screen output image at frame 13, the weighted fusion mode for the weighted fusion of the first image and the second image is mix(F(5),F(6),0.75), where 0.75 is the weight of F(6) of the second image, and after the frame filling between frame 10 and frame 11 is completed, when the effect capture image taken in real time is frame 14, the screen output image at frame 14 is frame 11 of the effect capture image. According to the same method, frames are filled between frame 11 of the effect capture image and frame 12 of the effect capture image. Frame 11 of the effect capture image is the first image, frame 12 of the effect capture image is the second image, and frames 15-17 of the target display image are filled, respectively, the weighted fusion modes of the first image and the second image are mix(F(4), F(5), 0.25, mix(F(3), F(4), 0.5 and mix(F(2),F(3), F(3), 0.75), where 0.25, 0.5, and 0.75 are the weights of the second image. After filling frame for frame 11 of the effect capture image and frame 12 of the effect capture image, the displayed target display image is frame 12 of the effect capture image, and the preset cache window caches frames 11-18.

In the slow-fast process, also referring to FIG. 7, after the screen outputs frame 12, the displayed image may be adjusted by skipping frames to the real-time cached image. Specifically, frames 19-21 output on the screen may correspond to frames 15, 18, and 21 of the effect capture image, respectively. By skipping 3 frames, the image output on the screen is adjusted to frame 21 of the effect capture image captured in real time at frame 21 of the target display image.

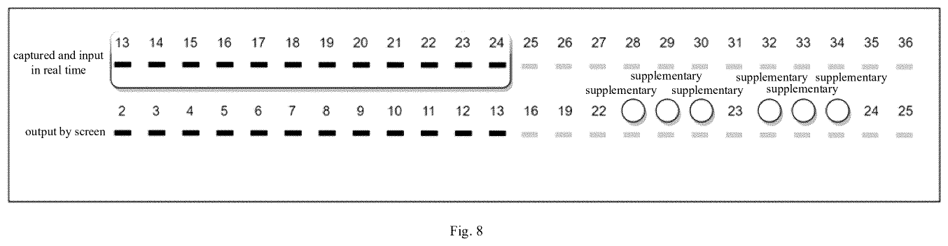

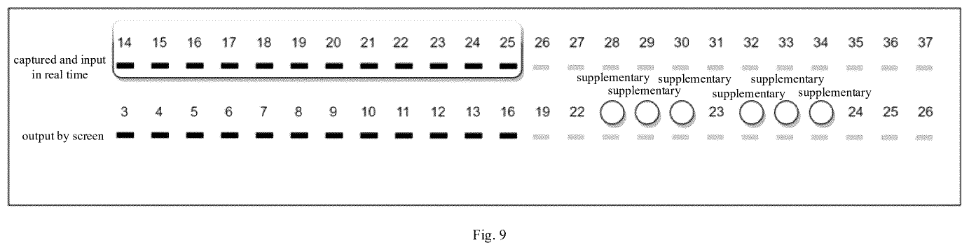

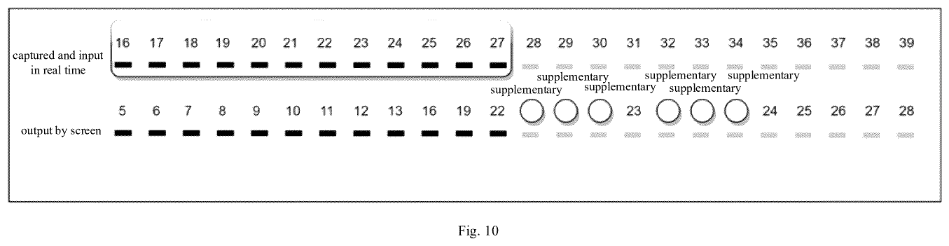

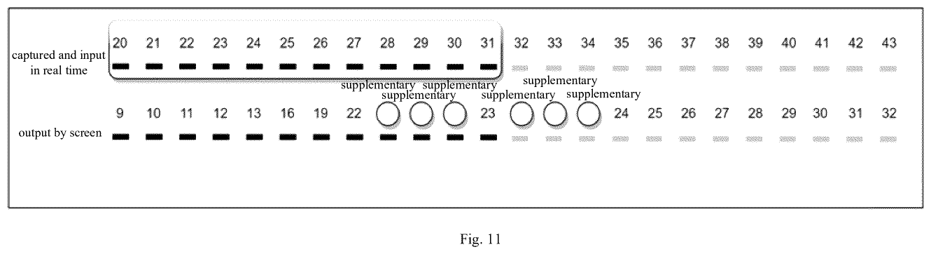

FIG. 8 is a schematic diagram of an example of performing effect processing on an effect capture image in a slow-fast-slow mode provided by the embodiment of the present disclosure. FIG. 9 is a schematic diagram of another example of performing effect processing on an effect capture image in a slow-fast-slow mode provided by the embodiment of the present disclosure. FIG. 10 is a schematic diagram of another example of performing effect processing on an effect capture image in a slow-fast-slow mode provided by the embodiment of the present disclosure. FIG. 11 is a schematic diagram of another example of performing effect processing on an effect capture image in a slow-fast-slow mode provided by the embodiment of the present disclosure.

It is assumed that the second number of preset frames for delayed display is 12 frames. F(n) is used to indicate the position of the effect capture image in the preset cache window, and n is taken from 1 to 12. As shown in FIG. 8, a preset speed-change condition is triggered at frame 24 of the effect capture image that is captured and input in real time, and the target display image output on the screen is frame 13 of the effect capture image.

As in FIG. 9, FIG. 8 shows that in the fast-slow mode, the first speed is lower than the second speed, and it is assumed that the preset number of skipped frames corresponding to the second speed is 3. When the effect capture image that is captured is frame 25 of the effect capture image, the target display image output on the screen is the image with 3 frames skipped after frame 13, that is, the cached image 16 of the effect capture image. As shown in FIG. 10, frames of the target display image that is output are skipped. When the effect capture image that is captured is frame 26 of the effect capture image, the target display image output on the screen is the image with 3 frames skipped after frame 16, that is, the cached image 19 of the effect capture image. When the effect capture image that is captured is frame 27 of the effect capture image, the target display image output on the screen is the image with 3 frames skipped after frame 19, that is, frame 22 of the effect capture image in the cached image.

In this case, the second preset number of frames for delayed display is 6 frames. In this case, frames may be filled, such that delayed frames of the adjusted target display image output on the screen equal to the second preset number of frames, that is, 12 frames. In this case, frames to be filled are the difference between the second preset number of frames and the number of currently delayed frames, that is, 6 frames. In order to maintain continuity between the effect capture images, the number of supplementary frames between every two frames of the effect capture images may be set to gradually restore the first speed. As shown in FIG. 11, frames are filled between frame 22 of the effect capture image and frame 23 of the effect capture image output on the screen. Then, 3 frames are filled between frames 22 and 23, and then, 3 frames are filled between frames 23 and 24.

Specifically, when the effect capture image captured and input in real time are frames 28-30, the target display image output on the screen should be a 3-frame supplementary image for frame 22 and frame 23, the frame filling process is as follows: frame 22 of the effect capture image is obtained as the first image, the cached image 23 of the effect capture image is obtained as the second image, frame 23 of image output on the screen is obtained by the weighted fusion on the first image and the second image with the formula mix(F(6),F(7),0.25), where 0.25 is the weight of F(7). Similarly, after filling the supplementary image corresponding to frame 28 captured and input in real time, the supplementary image corresponding to frame 29 and frame 30 captured and input in real time is continued to be filled. When the supplementary image corresponding to frame 29 is continued to be filled, the weighted fusion formula for the weighted fusion on the first image and the second image is mix(F(5),F(6),0.5), where 0.5 is the weight of F(6). When the supplementary image corresponding to frame 30 is continued to be filled, the weighted fusion formula for the weighted fusion on the first image and the second image is mix(F(4),F(5),0.75), where 0.75 is the weight of F(5). With the same method, frames are filled between frame 23 of the effect capture image and frame 24 of the effect capture image. After the frames are filled, when the effect capture image captured and input in real time is frame 35 of the effect capture image, the cached image output on the screen and frame 35 of the effect capture image are separated by 12 frames, that is, the corresponding frame in the cached image is frame 24. In this case, the effect capture image output on the screen is delayed by the second preset number of frames relative to the cached image.

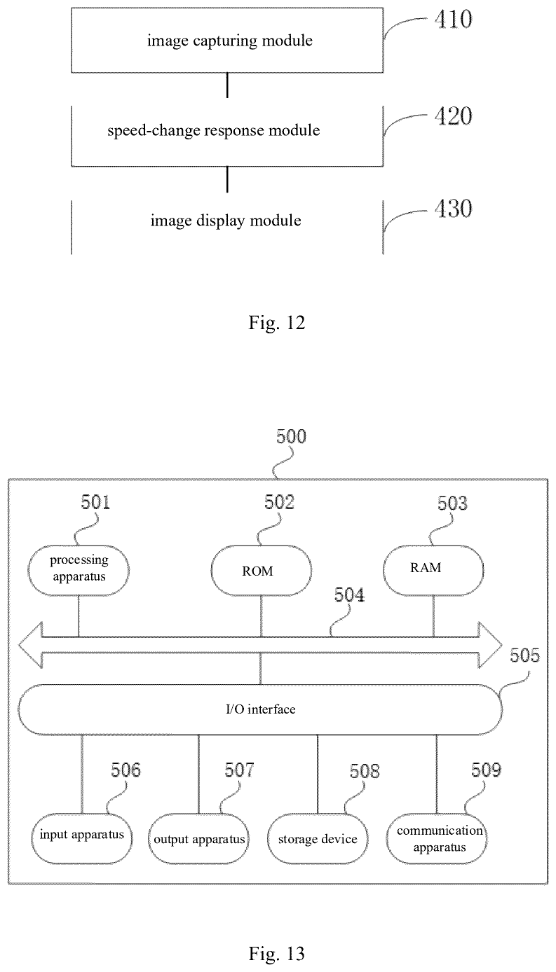

FIG. 12 is a structural schematic diagram of an effect processing apparatus provided by an embodiment of the present disclosure. As shown in FIG. 5, the apparatus includes: an image capturing module 410, a speed-change response module 420, and an image display module 430.

The image capturing module 410 is configured to display, in response to an effect trigger operation for a target speed-change effect, the effect capture image, a capture object in the effect capture image is displayed at a first speed. The speed-change response module 420 is configured to determine, when it is detected that a preset speed-change condition is reached, a target display image corresponding to a second speed based on the effect capture image, the first speed, and the second speed. The image display module 430 is configured to display the target display image corresponding to the second speed, such that the capture object in the effect capture image is displayed at the second speed.

In the embodiments of the present disclosure, the effect capture image is displayed in response to the effect trigger operation for the target speed-change effect, the capture object in the effect capture image is displayed at the first speed, such that capturing can be carried out in the application scenario of the target speed-change effect, a speed-change effect can be provided in the capturing process, which requires no manual post processing from the user, thereby providing simple interaction and convenient operation. Then, when it is detected that the preset speed-change condition is reached, the target display image corresponding to the second speed is determined based on the effect capture image, the first speed, and the second speed. During the capturing process, the target display image at the second speed can be automatically determined according to the effect capture image at the first speed, so as to achieve the speed-change effect. Finally, the target display image corresponding to the second speed is displayed, so that the capture object in the effect capture image is displayed at the second speed, such that the user can immediately view the speed-change effect after applying the target speed-change effect in the capturing process, thereby providing the speed-change effect while capturing, and improving the high-class experience and rhythm of the effect capture image. It solves the technical problem of cumbersome operation and poor timeliness caused by performing speed-change effect through video post-processing, displays the effect capture image in a speed-change manner, and simplifies the speed-change operation mode, thereby saving the effect processing time, improving the timeliness of speed-change display, and improving the technical effect of user interaction and viewing experience.

Optionally, the image capturing module is specifically configured to:
obtain an effect capture image, and cache the effect capture image based on a preset cache window to obtain a cached image;
display the effect capture image based on the cached image and a speed-change mode corresponding to the target speed-change effect.

Optionally, the image capturing module is further specifically configured to:
display, in response to that the speed-change mode corresponding to the target speed-change effect is a fast-to-slow mode, the cached image in real time; or
display, in response to that the speed-change mode corresponding to the target speed-change effect is a fast-to-slow mode, the effect capture image by delaying a first preset number of frames based on the cached image.

Optionally, the image capturing module is further specifically configured to:

display, in response to that the speed-change mode corresponding to the target speed-change effect is a slow-to-fast mode, the effect capture image by delaying a second preset number of frames based on the cached image.

Optionally, the speed-change response module is further specifically configured to:

obtain, in response to that the first speed is lower than the second speed, the effect capture image from the cached image as a target display image corresponding to the second speed based on the currently displayed effect capture image and a preset number of skipped frames corresponding to the second speed.

Optionally, the speed-change response module is further specifically configured to:
obtain, in response to that the first speed is greater than the second speed, the currently displayed effect capture image as a first image, and take the effect capture image of the next frame of the first image from the cached image as a second image;
determine a supplementary image with a preset number of supplementary frames corresponding to the second speed based on the first image and the second image, and successively take the supplementary image with the preset number of supplementary frames and the second image as the target display image corresponding to the second speed.

Optionally, the speed-change response module is further specifically configured to:
perform weighted fusion on the first image and the second image to obtain the supplementary image with the preset number of supplementary frames corresponding to the second speed.

Optionally, the speed-change response module is specifically configured that the preset speed-change condition includes at least one of the following conditions:
the audio information associated with the target speed-change effect is played to a preset audio node;
the effect capture image includes preset image information, the preset image information including a preset image main body and/or preset action information;
a control instruction for triggering the start of a speed-change is received, the control instruction is generated based on an input sound and/or based on a control trigger operation on a preset control; and
the duration of the effect capture image reaches a first preset duration.

Optionally, the apparatus further includes a restoration response module.

The restoration response module is configured to determine, when it is detected that a preset restoration condition is reached, the target display image corresponding to the first speed based on the currently displayed effect capture image, the first speed, and the second speed.

The image display module is specifically further configured to display the target display image corresponding to the first speed, such that the capture object in the effect capture image is changed from the second speed to be displayed at the first speed.

Optionally, the restoration response module is specifically configured that the preset speed-change condition includes at least one of the following conditions:
the preset restoration condition includes at least one of the following conditions:
the duration of the capture object in the effect capture image reaches a second preset duration;
the total number of effect capture images displayed at the second speed reaches a first preset quantity;
the total display number of target display images corresponding to the second speed reaches a second preset quantity.

The effect processing apparatus provided by the embodiments of the present disclosure can implement the effect processing method provided by any embodiment of the present disclosure, with a corresponding functional module and beneficial effect for implementing the method.

It should be noted that each unit and module included in the foregoing apparatus is only divided according to the functional logic, but it is not limited to the division above, as long as the corresponding function can be realized. In addition, the specific names of individual functional units are only for the convenience of distinguishing them from each other and are not used to limit the protect scope of the embodiments of the present disclosure.

FIG. 13 is a schematic structural diagram of an electronic device provided by an embodiment of the present disclosure. Referring to FIG. 13, FIG. 13 shows a structural schematic diagram of an electronic device 500 (such as a terminal device or a server in FIG. 13) suitable for the implementing the embodiments of the present disclosure. The terminal device in the embodiments of the present disclosure may include, but is not limited to, movable terminal such as a mobile phone, a laptop, a digital radio receiver, a personal digital assistant (PDA), a portable multimedia player (PMP), a vehicle terminal (for example, a vehicle navigation terminal) and a fixed terminal such as a digital TV, a desktop computer, and the like. The electronic device 500 shown in FIG. 13 is only an example and does not impose any restrictions on the functionality and scope of use of the embodiments of the present disclosure.

As shown in FIG. 13, an electronic device 500 may include a processing apparatus 501 (for example, a central processing unit, a graphics processing unit the like) that can perform various appropriate actions and processes according to a program stored in a read-only memory (ROM) 502 or loaded from a storage device 508 into a random-access memory (RAM) 503. In the RAM 503, various programs and data necessary for the operation of the electronic device 500 are also stored. The processing apparatus 501, the ROM 502 and the RAM 503 are connected to each other through a bus 504. An input/output (I/O) interface 505 is also connected to the bus 504.

In general, the following apparatus may be connected to the I/O interface 505: an input apparatus 506 including, for example, a touch screen, a touchpad, a keyboard, a mouse, a camera, a microphone, an accelerometer, a gyroscope, and the like; an output apparatus 507 including for example a liquid crystal display (LCD), a loudspeaker, a vibrator, or the like; a storage device 508 including for example a tape, a hard disk, or the like; and a communication apparatus 509. The communication apparatus 509 may allow the electronic device 500 to communicate wirelessly or wired with another electronic device for exchange of data. Although FIG. 13 shows an electronic device 500 with various apparatuses, it should be understood that it is not required to implement or have all of the apparatuses shown. It is possible to implement alternatively or to have more or fewer apparatuses.

Particularly, according to the embodiments of the present disclosure, the processes described in the above reference flowchart may be implemented as a computer software program. For example, an embodiment of the present disclosure includes a computer program product including a computer program carried on a non-volatile computer-readable medium that includes program codes for executing a method shown in a flowchart. In such an embodiment, the computer program may be downloaded and installed from a network through a communication apparatus 509, or installed from a storage device 508, or from a ROM 502. When the computer program is executed by the processing apparatus 501, the functions specified in the method of the embodiments of the present disclosure are performed.

The names of messages or information exchanged between multiple apparatuses in the implementations of the present disclosure are for illustrative purposes only and are not intended to limit the scope of the messages or information.

The electronic device provided by the embodiments of the present disclosure belongs to the same inventive idea as the effect processing method provided by the foregoing embodiments, and reference may be made to the foregoing embodiments for the technical details not described in detail in the present embodiment, and the present embodiment has the same beneficial effect as the foregoing embodiments.

The embodiments of the present disclosure provide a computer storage medium with a computer program stored thereon, which, when being executed by a processor, implements the effect processing method provided in the foregoing embodiments.

It should be noted that the computer-readable medium described in the present disclosure may be a computer-readable signal medium, a computer-readable storage medium, or any combination thereof. For example, a computer-readable storage medium may be, but is not limited to, electrical, magnetic, optical, electromagnetic, infrared, or semiconductor systems, apparatuses, or devices, or any combination thereof. More specific examples of the computer-readable storage medium may include, but are not limited to, an electrical connection based on one or more wires, a portable computer drive, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium containing or storing a program that may be used by or used in combination with a command execution system, apparatus, or device. In the present disclosure, a computer-readable signal medium may include a data signal propagated in the baseband or as part of a carrier wave, which carries computer-readable program codes. The data signal propagated may be implemented in many forms, including, but not limited to, an electromagnetic signal, an optical signal, or any suitable combination thereof. The computer-readable signal medium may also be any computer-readable medium other than a computer-readable storage medium, which may send, propagate or transmit programs intended for use by or in combination with an instruction-executing system, apparatus, or device. The program codes contained on the computer-readable medium may be transmitted on any appropriate medium, including, but not limited to, a wire, a fiber optic cable, an RF (radio frequency), or the like, or any appropriate combination thereof.

In some embodiments, a client, or a server may communicate using any currently known or future-developed network protocol such as Hypertext Transfer Protocol (HTTP), and may be interconnected with any digital data communication in any form or medium (for example, a communication network). Examples of the communication network include a local area network (LAN), a wide area network (WAN), an inter-network (for example, the Internet), and an end-to-end network (for example, an ad hoc end-to-end network), as well as any network known at present or to be developed in the future.

The computer-readable medium described above may be contained in the electronic device described above. It may also exist on its own and not be assembled into the electronic device.

The computer-readable medium carries one or more programs, which, when being executed by the electronic device, causes the electronic device to: display, in response to an effect trigger operation for a target speed-change effect, an effect capture image, a capture object in the effect capture image being displayed at a first speed; determine, when it is detected that a preset speed-change condition is reached, a target display image corresponding to a second speed based on the effect capture image, the first speed, and the second speed; and display the target display image corresponding to the second speed, such that the capture object in the effect capture image is displayed at the second speed.

The computer program codes for performing the operations of the present disclosure may be written in one or more programming languages, or a combination thereof, including, but not limited to, an object-oriented programming language, such as Java, Smalltalk, C++, and may also include a conventional procedural programming language, such as the Combined Programming Language (C language) or a similar programming language. The program codes may be executed entirely on a user computer, partially on a user computer, as a stand-alone software package, partly on a user computer and partly on a remote computer, or entirely on a remote computer or server. When a remote computer is involved, the remote computer may be connected to the user computer through any network, including a local area network (LAN) or wide area network (WAN), or may be connected to an external computer (for example, by the Internet through an Internet service provider).

The flowcharts and block diagrams in the accompanying drawings illustrate the architecture, functions, and operations that may be implemented in accordance with the systems, methods, and computer program products in the various embodiments of the present disclosure. In this regard, each box in a flowchart or block diagram may represent a module, a program segment, or a part of codes that contain one or more executable instructions for implementing a specified logical function. It should also be noted that in some implementations as an alternative, the functions indicated in the boxes may also occur in a different order than those indicated in the drawings. For example, two successive boxes may actually be executed in essentially parallel order, and they can sometimes be executed in a reverse order, depending on the function involved. It should also be noted that each box in the block diagram and/or flowchart, and a combination of the boxes in the block diagram and/or flowchart, may be implemented with a dedicated hardware-based system that performs a defined function or operation, or with a combination of dedicated hardware and computer instructions.

The unit described in the embodiments of the present disclosure may be implemented by means of software or by means of hardware. The name of a unit does not constitute limitation to the unit itself in some cases. For example, the first acquisition unit may also be described as “a unit that obtains at least two Internet Protocol addresses”.

The functions described above herein may be performed at least in part by one or more hardware logic components. As a non-limiting example, exemplary hardware logic components that can be used includes: a field-programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable storage medium may be a tangible medium containing or storing a program to be used by, or in combination with an instruction execution system, apparatus or device. The machine-readable medium may be either a machine-readable signal medium or a machine-readable storage medium. The machine-readable medium may include, but is not limited to, an electronic, magnetic, optical, electromagnetic, infrared, or semiconductor system, apparatus, or device, or any appropriate combination thereof. More specific examples of the machine-readable medium may include an electrical connection based on one or more wires, a portable computer drive, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, an example 1 provides an effect processing method, including:
displaying, in response to an effect trigger operation for a target speed-change effect, an effect capture image, a capture object in the effect capture image being displayed at a first speed;
determining, when it is detected that a preset speed-change condition is reached, a target display image corresponding to a second speed based on the effect capture image, the first speed, and the second speed; and
displaying the target display image corresponding to the second speed, so that the capture object in the effect capture image is displayed at the second speed.

According to one or more embodiments of the present disclosure, an example 2 provides an effect processing method, including:
optionally, the displaying the effect capture image includes:
obtaining the effect capture image, and caching the effect capture image based on a preset cache window to obtain a cached image;
display the effect capture image based on the cached image and a speed-change mode corresponding to the target speed-change effect.

According to one or more embodiments of the present disclosure, an example 3 provides an effect processing method, including:
optionally, the displaying the effect capture image based on the cached image and a speed-change mode corresponding to the target speed-change effect includes:
displaying, in response to that the speed-change mode corresponding to the target speed-change effect is a fast-to-slow mode, the cached image in real time; or
displaying, in response to that the speed-change mode corresponding to the target speed-change effect is a fast-to-slow mode, the effect capture image by delaying a first preset number of frames based on the cached image.

According to one or more embodiments of the present disclosure, an example 4 provides an effect processing method, including:
optionally, the displaying the effect capture image based on the cached image and a speed-change mode corresponding to the target speed-change effect includes:
displaying, in response to that the speed-change mode corresponding to the target speed-change effect is a slow-to-fast mode, the effect capture image by delaying a second preset number of frames based on the cached image.

According to one or more embodiments of the present disclosure, an example 5 provides an effect processing method, including:
optionally, the determining a target display image corresponding to a second speed based on the effect capture image, the first speed, and the second speed includes:
obtaining, in response to that the first speed is lower than the second speed, the effect capture image from the cached image as a target display image corresponding to the second speed based on the currently displayed effect capture image and a preset number of skipped frames corresponding to the second speed.

According to one or more embodiments of the present disclosure, an example 6 provides an effect processing method, including:
optionally, the determining a target display image corresponding to a second speed based on the effect capture image, the first speed, and the second speed includes:
obtaining, in response to that the first speed is greater than the second speed, the currently displayed effect capture image as a first image, and obtaining the effect capture image of the next frame of the first image from the cached image as a second image;
determining a supplementary image with a preset number of supplementary frames corresponding to the second speed based on the first image and the second image, and successively taking the supplementary image with the preset number of supplementary frames and the second image as the target display image corresponding to the second speed.

According to one or more embodiments of the present disclosure, an example 7 provides an effect processing method, including:
optionally, the determining a supplementary image with a preset number of supplementary frames corresponding to the second speed based on the first image and the second image includes:
performing weighted fusion on the first image and the second image to obtain the supplementary image with the preset number of supplementary frames corresponding to the second speed.

According to one or more embodiments of the present disclosure, an example 8 provides an effect processing method, including:
optionally, a preset restoration condition includes at least one of the following conditions:
audio information associated with the target speed-change effect is played to a preset audio node;
the effect capture image includes preset image information, the preset image information including a preset image main body and/or preset action information;
a control instruction for triggering the start of a speed-change is received, the control instruction being generated based on an input sound and/or based on a control trigger operation on a preset control; and
the duration of the effect capture image reaches a first preset duration.

According to one or more embodiments of the present disclosure, an example 9 provides an effect processing method, including:
optionally, the method further includes:
determining, when it is detected that a preset restoration condition is reached, a target display image corresponding to the first speed based on the currently displayed effect capture image, the first speed, and the second speed;
displaying the target display image corresponding to the first speed, so that the capture object in the effect capture image is changed from the second speed to be displayed at the first speed.

According to one or more embodiments of the present disclosure, an example 10 provides an effect processing method, including:
optionally, the preset restoration condition includes at least one of the following conditions:
a duration of displaying the capture object in the effect capture image at the second speed reaches a second preset duration;
the total number of effect capture images displayed at the second speed reaches a first preset quantity;
the total display number of target display images corresponding to the second speed reaches a second preset quantity.

According to one or more embodiments of the present disclosure, an example 11 provides an effect processing apparatus, including:
an image capturing module configured to display, in response to an effect trigger operation for a target speed-change effect, an effect capture image, a capture object in the effect capture image being displayed at a first speed;
a speed-change response module configured to determine, when it is detected that a preset speed-change condition is reached, a target display image corresponding to a second speed based on the effect capture image, the first speed, and the second speed; and
an image display module configured to display the target display image corresponding to the second speed, so that the capture object in the effect capture image is displayed at the second speed.

The above description is only the preferred embodiment of the present disclosure and the explanation of the applied technical principles. It should be understood by those skilled in the art that the disclosure scope involved in this disclosure is not limited to the technical scheme formed by the specific combination of the above technical features, but also covers other technical schemes formed by any combination of the above technical features or their equivalent features without departing from the above disclosure concept. For example, the above features are replaced with (but not limited to) technical features with similar functions disclosed in this disclosure.

Furthermore, although operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or method logical actions, it should be understood that the subject matter defined in the appended claims is not necessarily limited to the specific features or actions described above. On the contrary, the specific features and actions described above are only exemplary forms of implementing the claims.

1. An effect processing method, comprising:
displaying, in response to an effect trigger operation for a speed-change effect, an effect capture image, wherein a capture object in the effect capture image is displayed at a first speed;
determining, when it is detected that a preset speed-change condition is reached, a display image corresponding to a second speed based on the effect capture image, the first speed, and the second speed; and
displaying the display image corresponding to the second speed, so that the capture object in the effect capture image is displayed at the second speed.

2. The effect processing method according to claim 1, wherein the displaying an effect capture image comprises:
obtaining the effect capture image, and caching the effect capture image based on a preset cache window to obtain a cached image;
displaying the effect capture image based on the cached image and a speed-change mode corresponding to the speed-change effect.

3. The effect processing method according to claim 2, wherein the displaying the effect capture image based on the cached image and a speed-change mode corresponding to the speed-change effect comprises:
displaying, in response to that the speed-change mode corresponding to the speed-change effect is a fast-to-slow mode, the cached image in real time; or
displaying, in response to that the speed-change mode corresponding to the speed-change effect is a fast-to-slow mode, the effect capture image by delaying a first preset number of frames based on the cached image.

4. The effect processing method according to claim 2, wherein the displaying the effect capture image based on the cached image and a speed-change mode corresponding to the speed-change effect comprises:
displaying, in response to that the speed-change mode corresponding to the speed-change effect is a slow-to-fast mode, the effect capture image by delaying a second preset number of frames based on the cached image.

5. The effect processing method according to claim 4, wherein the determining a display image corresponding to a second speed based on the effect capture image, the first speed, and the second speed comprises:
obtaining, in response to that the first speed is lower than the second speed, the effect capture image from the cached image as a display image corresponding to the second speed based on a currently displayed effect capture image and a preset number of skipped frames corresponding to the second speed.

6. The effect processing method according to claim 2, wherein the determining a display image corresponding to a second speed based on the effect capture image, the first speed, and the second speed comprises:
obtaining, in response to that the first speed is greater than the second speed, the currently displayed effect capture image as a first image, and obtaining the effect capture image of a next frame of the first image from the cached image as a second image;
determining a supplementary image with a preset number of supplementary frames corresponding to the second speed based on the first image and the second image, and successively taking the supplementary image with the preset number of supplementary frames and the second image as the display image corresponding to the second speed.

7. The effect processing method according to claim 6, wherein the determining a supplementary image with a preset number of supplementary frames corresponding to the second speed based on the first image and the second image comprises:
performing weighted fusion on the first image and the second image to obtain the supplementary image with the preset number of supplementary frames corresponding to the second speed.

8. The effect processing method according to claim 1, wherein a preset speed-change condition comprises at least one of the following:
audio information associated with the speed-change effect is played to a preset audio node;
the effect capture image comprises preset image information, wherein the preset image information comprises a preset image main body and/or preset action information;
a control instruction for triggering the start of a speed-change is received, wherein the control instruction is generated based on an input sound and/or based on a control trigger operation on a preset control; and
a duration of capturing the effect capture image reaches a first preset duration.

9. The effect processing method according to claim 1, wherein after displaying the capture object in the effect capture image at the second speed, the effect processing method further comprises:
determining, when it is detected that a preset restoration condition is reached, a display image corresponding to the first speed based on a currently displayed effect capture image, the first speed, and the second speed;
displaying the display image corresponding to the first speed, so that the capture object in the effect capture image is changed from the second speed to be displayed at the first speed.

10. The effect processing method according claim 9, wherein a preset restoration condition comprises at least one of the following:
a duration of displaying the capture object in the effect capture image at the second speed reaches a second preset duration;
the total number of effect capture images displayed at the second speed reaches a first preset quantity; and
the total display number of display images corresponding to the second speed reaches a second preset quantity.

11-20. (canceled)

21. An electronic device, comprising:
at least a processor, and
a non-transitory memory with instructions thereon,
wherein the instructions upon execution by the processor, cause the processor to:
display, in response to an effect trigger operation for a speed-change effect, an effect capture image, wherein a capture object in the effect capture image is displayed at a first speed;
determine, when it is detected that a preset speed-change condition is reached, a display image corresponding to a second speed based on the effect capture image, the first speed, and the second speed; and
display the display image corresponding to the second speed, so that the capture object in the effect capture image is displayed at the second speed.

22. A storage medium containing a computer-executed instruction, wherein the computer-executed instruction, when executed by a computer processor, cause the computer processor to perform the effect processing method according to claim 1.

23. The electronic device according to claim 21, wherein the processor is further caused to:
obtain the effect capture image, and cache the effect capture image based on a preset cache window to obtain a cached image;
display the effect capture image based on the cached image and a speed-change mode corresponding to the speed-change effect.

24. The electronic device according to claim 23, wherein the processor is further caused to:
display, in response to that the speed-change mode corresponding to the speed-change effect is a fast-to-slow mode, the cached image in real time; or
display, in response to that the speed-change mode corresponding to the speed-change effect is a fast-to-slow mode, the effect capture image by delaying a first preset number of frames based on the cached image.

25. The electronic device according to claim 23, wherein the processor is further caused to:
display, in response to that the speed-change mode corresponding to the speed-change effect is a slow-to-fast mode, the effect capture image by delaying a second preset number of frames based on the cached image.

26. The electronic device according to claim 25, wherein the processor is further caused to:
obtain, in response to that the first speed is lower than the second speed, the effect capture image from the cached image as a display image corresponding to the second speed based on a currently displayed effect capture image and a preset number of skipped frames corresponding to the second speed.

27. The electronic device according to claim 23, wherein the processor is further caused to:
obtain, in response to that the first speed is greater than the second speed, the currently displayed effect capture image as a first image, and obtain the effect capture image of a next frame of the first image from the cached image as a second image;
determine a supplementary image with a preset number of supplementary frames corresponding to the second speed based on the first image and the second image, and successively take the supplementary image with the preset number of supplementary frames and the second image as the display image corresponding to the second speed.

28. The electronic device according to claim 27, wherein the processor is further caused to:
perform weighted fusion on the first image and the second image to obtain the supplementary image with the preset number of supplementary frames corresponding to the second speed.

29. The electronic device according to claim 21, wherein the processor is further caused to:
determine, when it is detected that a preset restoration condition is reached, a display image corresponding to the first speed based on a currently displayed effect capture image, the first speed, and the second speed;
display the display image corresponding to the first speed, so that the capture object in the effect capture image is changed from the second speed to be displayed at the first speed.

30. The electronic device according to claim 29, wherein a preset restoration condition comprises at least one of the following:
a duration of displaying the capture object in the effect capture image at the second speed reaches a second preset duration;
the total number of effect capture images displayed at the second speed reaches a first preset quantity; and
the total display number of display images corresponding to the second speed reaches a second preset quantity.
